(19) United States
(12) Patent Application Publication
(10) Pub. No.: US 2023/0093385 A1
(43) Pub. Date: Mar. 23, 2023

(54) VISIBILITY-BASED ATTRIBUTE DETECTION

(71) Applicant: Microsoft Technology Licensing, LLC, Redmond, WA (US)

(72) Inventors: Zvi FIGOV, Modiin (IL); Mattan SERRY, Herzliya (IL)

(21) Appl. No.: 17/478,092

(22) Filed: Sep. 17, 2021

(51) Int. Cl. G06K 9/62

(52) U.S. Cl. CPC G06K 9/6262; G06K 9/6259

(57) ABSTRACT

A computer-implemented method of accounting for visibility of a first attribute of one or more attributes associable with an object presented in an image is provided. The method includes inputting a training image of a first object into an attribute identification machine learning model, the training image being associated with labeled visibility data indicating whether the first attribute is visible in the inputted training image, generating, based on the inputted training image, visibility prediction data representing a prediction by the attribute identification machine learning model as to whether the first attribute is predicted to be visible in the inputted training image, comparing the generated visibility prediction data with labeled visibility data, and modifying the attribute identification machine learning model based on the comparison of the generated visibility prediction data and the labeled visibility data.

### BACKGROUND

Computer vision systems take in images as input and output determinations based on the relationships in images, such as curved and edged features. Computer vision systems can incorporate machine learning models to learn these features and identify objects in images. The identified objects in the images can be analyzed based on elements and attributed associated with the objects.

### SUMMARY

The described technology provides a computer-implemented method of accounting for visibility of a first attribute of one or more attributes associable with an object presented in an image. The method includes inputting a training image of a first object into an attribute identification machine learning model, the training image being associated with labeled visibility data indicating whether the first attribute is visible in the inputted training image, generating, based on the inputted training image, visibility prediction data representing a prediction by the attribute identification machine learning model as to whether the first attribute is predicted to be visible in the inputted training image, comparing the generated visibility prediction data with labeled visibility data, and modifying the attribute identification machine learning model based on the comparison of the generated visibility prediction data and the labeled visibility data.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example system that accounts for visibility of attributes associable with an object presented in an image.

FIG. 2 illustrates an example computing system that accounts for visibility of attributes in training an attribute identification model.

FIG. 3 illustrates another example computing system that accounts for visibility of attributes in training an attribute identification model.

FIG. 4 illustrates still another example computing system that accounts for visibility of attributes presented in an image for detection of the attributes.

FIG. 5 illustrates an example of a tracking computer system.

FIG. 6 illustrates examples of images of objects and visibility of associated attributes.

FIG. 7 illustrates example computer-readable media.

FIG. 8 illustrates example operations for training an attribute identification model.

FIG. 9 illustrates example operations for generating attribute data using an attribute identification model.

FIG. 10 illustrates example operations for using generated attribute data in a tracking application.

FIG. 11 illustrates an example computing device for implementing the features and operations of the described technology.

### DETAILED DESCRIPTIONS

Computer vision systems are used in many industrial applications. Examples include security, autonomous locomotion, conservation studies, and traffic control systems. The ability to identify and track objects can be an important element of these systems.

The computer vision systems determine relationships between features of portions of the images in order to identify objects and draw bounding boxes around relative portions of the images that contain the objects. Some attributes of an object go beyond the detection and/or identification of the object itself. If the object is a human, there are visually perceptible and associable attributes with the human. Examples of these attributes include clothing, accessories, and portions of bare skin. Systems often account for the presence of these attributes in the image in general, but it is not clear that the attributes are associated within the same bounding box with the object that the computer system detects and/or identifies. The computer vision systems typically do not separate inquiries regarding the existence of an attribute associated or associable with an object in an image and the visibility of the attribute in the image.

The presently disclosed technology accounts for the visibility of attributes as a separate inquiry from whether the attributes actually exist in the image. For example, at least part of a lower portion of a person sitting at a table will be obscured by the table. In this image, there may be other data that suggests the presence or existence of pants or a skirt. The output of the system may indicate that the attribute of “pants” or “skirt” exists in association with a person. However, if there is sufficient occlusion, this information may be incorrect. The system may independently determine that the attributes are also not visible in the image. Given both an output representing visibility and a different output representing the existence of an attribute in association with the object may further inform whether the existence determination is trustworthy. For example, in systems where a person is tracked as an object in a series of video capture images, there may be memory associated with the person or a unique identifier associated with a person. The person may have been carrying a handbag for a bit, left the handbag under the table. The person may move to another table without the handbag. A computer vision system that does not account for the visibility of the bag may indicate that that the bag still exists in association with the person, even if the person left the bag at the other table. By indicating that the bag is not visible, the system can compensate in a number of ways. For example, the system could ignore images in which too many attributes are obscured or in which specific attributes of interest are not visible.

The separation of determinations of existence and visibility can help enhance the measurement of the existence of an attribute associated or associable with an object. For example, the attribute being both visible and in existence reinforces that the attribute actually exists in the image. Also, the visibility of some features is related. For example, if pants are not visible, it increases the likelihood that skirts are not visible either. In the case where a table obscures the lower part of a person's body. This interdependency can be reflected in a correlation array or matrix representing a correlation between visibility of different attributes. This correlation between visibility of different attributes can qualify the extent to which something is determined to exist in the image. Machine learning models can be trained to account for one or more of visibility of each attribute, correlation between visibility of the different attributes, existence of the attribute in association with the object, and qualification of the existence of the attribute based on visibility correlations between attributes.

The presently disclosed technology can have a number of applications. In some systems, the attribute visibility parameter can be used to determine whether an image should be used in tracking. Also, systems are contemplated in which computer vision systems are used to inventory and/or index attributes associated or associable with objects (such as humans) to make the attributes searchable elements. For example, airport security may want to find all people wearing blue jeans, a specific brand of backpack, glasses, and sneakers. With this description, a surveillance system may be able to reduce a search for someone to only a few individuals of thousands of individuals. Further, because the attributes are associated with people in the images, a track could be maintained with the individuals who qualify, perhaps facilitating live video feeds of all relevant individuals in the search.

By coloring determinations of the existence of attributes with determinations of the visibility of the attributes in the image, a more accurate and context-rich system can provide more accurate tracking. It could also be used in the context of live advertising, the advertising targeted at individuals based on detected associated attributes. Visibility as an independent determination for an attribute can reduce the likelihood of incorrect determinations of the presence of attributes, making the computer vision systems more robust and potentially allowing for faster training. Further, a search may be enhanced by searching for attributes of interest that are consistently not visible. For example, consistent detection that something is not visible may indicate that someone is trying to hide something. Any outlier in visibility detections could be isolated to find objects (e.g., persons) of interest. The visibility determination can also be used to potentially map locations of occluding objects that render attributes not visible. In this sense, one might be able to distinguish situations where attributes are being actively hidden by objects as opposed to merely being occluded by the environment.

In view of this specification, implementations of the presently described technology can provide improvements including one or more of more accurate attribute detection in association with identified objects, increased model training efficacy, decreased model training time, reductions in overfitting of data, better cataloging and indexing of attributes associated or associable with objects, better recognition of occluding elements, better environmental awareness, more convenient isolation of objects of interest based on associated attributes, and better detection of anomalous behavior of objects.

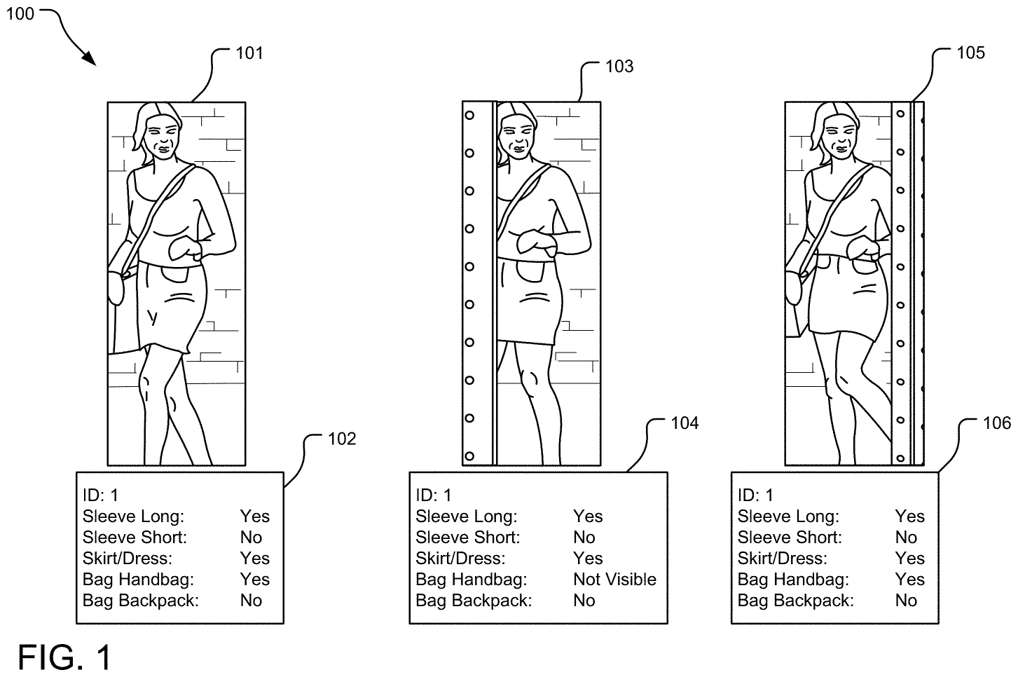

FIG. 1 illustrates an example system 100 that accounts for visibility of attributes associable with an object presented in an image. In the system 100, three images 101, 103, and 105 taken from a video sequence are presented three associated sets of detected attributes 102, 104, and 106 detected by a computer vision system. The first image illustrates a woman walking with a handbag. The first set of attribute detections 102 indicates that the woman has long sleeves, lacks short sleeves, is wearing a skirt or dress, has a handbag, and lacks a backpack. In the second image 103, it can be seen that a pole is in the foreground and obscures the handbag.

The second set of detected attributes 104 indicates that the woman has long sleeves, lacks short sleeves, is wearing a skirt or dress, and does not have a backpack. However, unlike the first image 101, the second image 103 has the handbag largely occluded by the pole in the foreground. A computer vision system trained to determine the visibility of attributes associated with the woman determines in the second set of detected attributes 104 that the handbag is not visible. The computer vision system may have determined that the handbag exists from context (e.g., based on the strap that is still visible or from memory associated with “ID:1” if the identifiers are associated with the object), but it may determine that the bag itself is not visible. In this implementation, the detection of not visible overrides a determination of whether the bag exists in association with the woman. Other systems are contemplated where both visibility determinations and existence determinations are provided. Moving to the third image 105, it can be seen that the woman has passed a position where the pole was obscuring her handbag. As such, the third set of attribute detections 106 is the same as the first set of attribute detections 102.

The originally captured images from an image capture device may include more than that which is shown in images 101, 103, and 105. For example, a machine learning or other inferential algorithm may be used to draw a bounding box around and/or otherwise isolate the portion of the image that is determined to contain the object. The machine learning model or inferential algorithm that establishes the bounding box may also assign an identifier to the cropped or isolated image of the object that represents one or more of the object identifier (e.g., the woman) or the particular cropped or isolated photo. Identifiers that identify the object may be used in tracking software to maintain a track on the same object of interest. When inputting images into an attribute identification model, the images may be pre-cropped or pre-isolated to provide better resolution in the training of the attribute identification model and better predictions of the objects and visibility and/or existence of attributes associated or associable with the object.

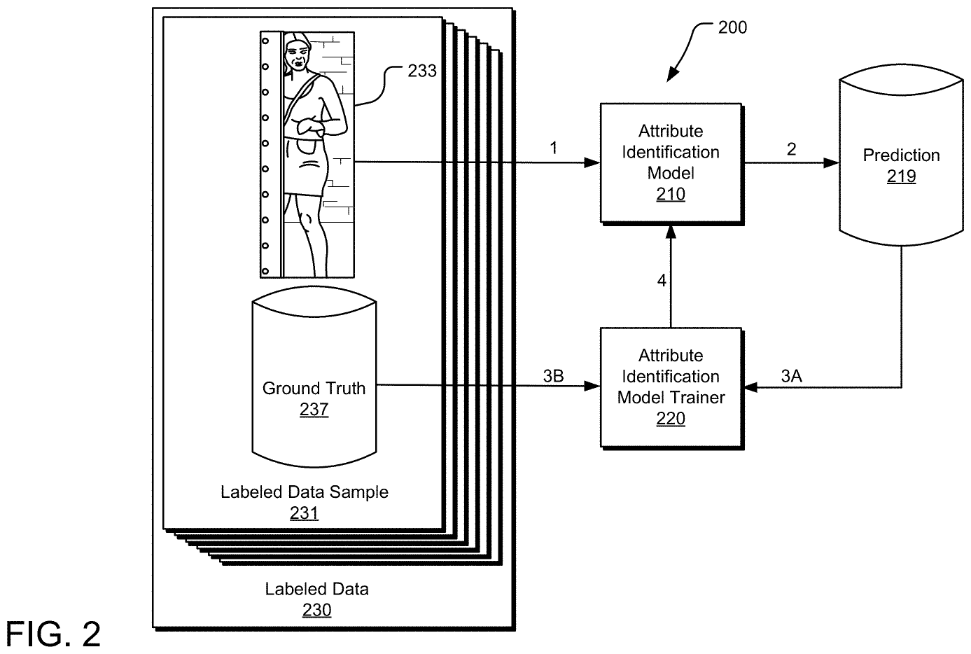

FIG. 2 illustrates an example computing system 200 that accounts for visibility of attributes in training an attribute identification model 210. The labeled data 230 may be introduced to storage of the computing system 200 to be used to train an attribute identification model 210. Image data representing an image 233 of a labeled data sample 231 is inputted into the attribute identification model 210 at arrow 1. The image 233 may be represented as a two-dimensional array of values (e.g., bit-level and/or byte-level value representations of pixels in color or greyscale).

The attribute identification model 210 may include an inferential model and/or a machine learning model executable by a processor of the computing system 200 to take the data representing image 233 as input and apply weights on edges between the nodes in the logic of the attribute identification model 210 to the data representing image 233. The machine learning model may be initialized with edges including randomized weights or with a pre-trained model for general or specific applications (e.g., for objects such as humans, pre-trained models exist to recognize features of humans). Activation functions may also be used to introduce nonlinearity to determinations at one or more nodes. Examples of activation functions include Sigmoid, rectified linear unit (ReLU), hyperbolic tangent (tan h), Maxout, Leaky ReLU, arctangent, SoftPlus, and exponential linear unit (ELU). Examples of inferential and/or machine learning models include data mining algorithms, artificial intelligence algorithms, masked learning models, natural language processing models, neural networks, artificial neural networks, perceptrons, feed-forward networks, radial basis neural networks, deep feed forward neural networks, recurrent neural networks, long/short term memory networks, gated recurrent neural networks, auto encoders, variational auto encoders, denoising auto encoders, sparse auto encoders, Bayesian networks, regression models, decision trees, Markov chains, Hopfield networks, Boltzmann machines, restricted Boltzmann machines, deep belief networks, deep convolutional networks, genetic algorithms, deconvolutional neural networks, deep convolutional inverse graphics networks, generative adversarial networks, liquid state machines, extreme learning machines, echo state networks, deep residual networks, Kohonen networks, support vector machines, federated learning models, and neural Turing machines.

The data representing the image 233 is passed through the attribute identification model 210 and the weights between edges are applied to provide node values (perhaps with activation functions) to eventually, at an output layer of output nodes, output a prediction 219 as represented by arrow 2. The prediction 219 can be assembled as an array of attribute values that represent the numerical values of likelihood of a condition being satisfied. For example, the results may yield a number between zero and one. Zero and one may be associated with a determination of falsity and truth, respectively, of the condition. This prediction 219 can be with regard to one or more of visibility of and existence of an attribute associated or associable with a detected object in the image. For example, the prediction 219 for visibility of a handbag on a person could have a value of 0.2. An interpreter in the computing system 200 could interpret the value of 0.2 to be closer to zero than one and indicate that the visibility is zero or “False.” Even if the person in the image 233 is wearing the handbag. Similarly, the prediction 219 for existence of the handbag could be 0.8. An interpreter could determine that the handbag exists, even if it is not visible. This may be because the implementation of the attribute identification model 210 includes memory from prior images in which the bag was determined to exist and be visible or because there is sufficient context in the image to determine that the handbag exists even if insufficiently visible to be considered visible. Interpreting in the training stage may be unnecessary, but the interpretation is presented here to provide context for the numbers of the prediction 219 and the ground truth 237.

Arrows 3A and 3B transmit the prediction 219 and a ground truth 237 of the labeled data sample 231 associated with image 233, respectively, to the attribute identification model trainer 220. Arrow 4 represents the attribute identification model trainer 220 training the attribute identification model 210 to conform predictions 219 to labeled ground truths 237 (at least in embodiments in which supervised or semi-supervised learning is employed). To do so, the attribute identification model trainer 220 modifies the attribute identification model 210 (e.g., at weights of its edges) based on a comparison between the prediction 219 and the ground truth 237. The comparison can include determining a difference or loss between the prediction 219 and the ground truth 237 and adjusting the weights at the edges of the attribute identification model 210 by backpropagating the difference or loss. Examples of loss functions include mean squared error, quadratic loss, L2 loss, mean absolute error, L1 loss, mean bias error, vector difference, hinge loss, support vector machine loss, (e.g., multiclass loss), cross-entropy, and negative log likelihood. As illustrated, the labeled data sample 231 is only one of a plurality of labeled data samples in the labeled data 230. As data representing more images like image 233 are introduced to make predictions 219 and the attribute identification model trainer compares them with the ground truth 237 to modify the attribute identification model 210, the attribute identification model should be better trained to make predictions 219 that are consistent with the trained ground truths 237. The attribute identification model 210 may also account for correlation between visibility of different attributes. Accounting for attribute visibility correlation in attribute existence determinations may reduce training times for the attribute identification model 210. Correlation between visibility of different attributes is described in reference to Code Example 1 and Table 1: Visibility Correlation Matrix presented in this specification.

The attribute identification model trainer 220 may continue to train the attribute identification model 210 with the labeled sample data 231 and may repeat with the labeled sample data in the same or different orders in the same or different iterations. The attribute identification model trainer 220 may continue to train the model until a training condition is satisfied.

The model attribute identification model trainer 220 may further validate the attribute identification model 210 by testing the outputs of different labeled image data (e.g., other than labeled data 230) that was not included in the training. This may facilitate validation that the attribute identification model has not overfit the labeled data 230. Failure in validation may indicate that the attribute identification model trainer should introduce further labeled data 230 to better train the model. Validation may be determined satisfactory based on whether a validation condition is satisfied.

The training condition and/or validation condition may include a threshold of loss or difference for comparison of labeled and ground truth data for one or more of attribute visibility, attribute existence, and attribute visibility correlation. The threshold may additionally or alternatively include a certain number of iterations or epochs of training. The training and/or validation condition may include consideration of one or more of accuracy, precision, harmonic mean of precision and recall (i.e., F1 score), and recall

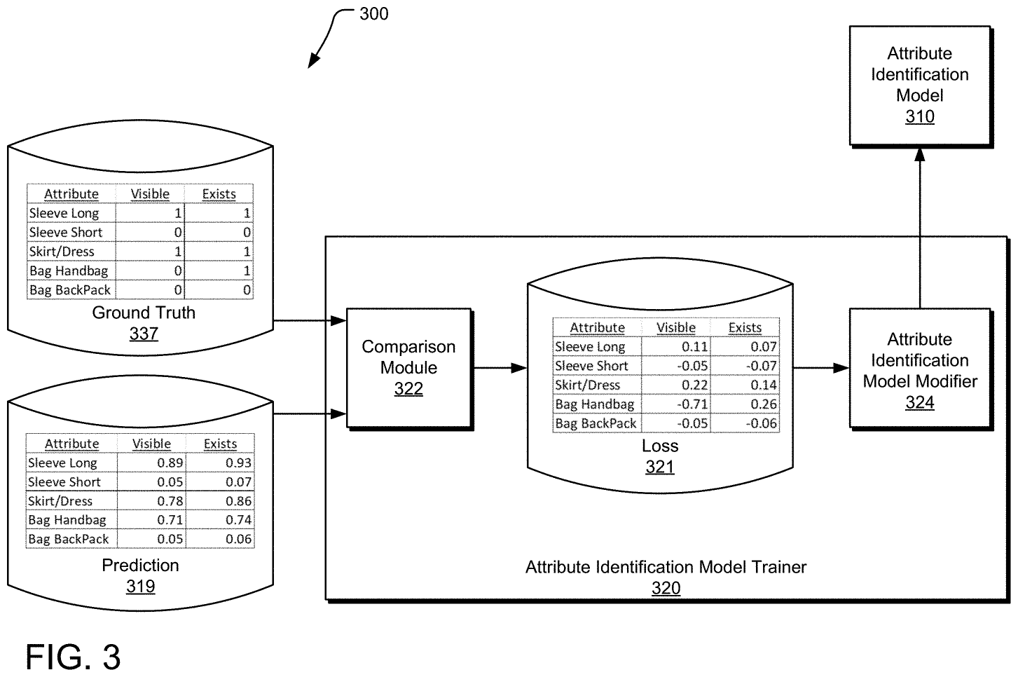

FIG. 3 illustrates another example computing system 300 that accounts for visibility of attributes in training an attribute identification model 310. The attribute identification model 310, attribute identification mode trainer 320, prediction 319, and ground truth 337 may be implementations of the attribute identification model 210, application identification trainer 220, prediction 219 and ground truth 237, respectively. The attribute identification model trainer 320 may include an image inputter (not illustrated) executable by a processor of the computing system 300 to input images into the attribute identification model 310 for processing. In order to compare a prediction outputted by an attribute identification model 310, the attribute identification model trainer may use a comparison module 322 executable by a processor of the computing system to compare the prediction 319 generated from introducing an image of a labeled training sample to the attribute identification model 310 with the ground truth of the labeled training sample.

In the illustrated implementation, the ground truth values are represented as zeroes and ones. The zeros and ones can represent falsity and truth, respectively, regarding a detection from a sample image. For example, as illustrated, the ground truth 237 (e.g., something a person determined from looking at the image prior to training) indicates that a handbag is not visible (value of zero) but exists (value of one). The predictions appear to be less uniform, having values that range between zero and one. While the values have been scaled to fit within the zero to one range, they do not clearly indicate a yes or no answer, as the zeros and ones do in the ground truth 237. The values may indicate relative probabilities of truth and falsity. One approach to interpreting these values is to round the values to the nearer of zero or one. For example, the prediction 319 detects that the handbag visibility has a value of 0.71 and existence has a value of 0.74. If a rounding approach is used, the results may be interpreted to indicate that the handbag is predicted to be visible (0.71 rounds to 1) and to exist (0.74 rounds to 1). During training, however, the interpretation may be unnecessary. Rounding of the values in the prediction 319 before comparison may result in lost information and cause poor training.

A comparison module 322 is executable by a processor of the computing system 300 to compare the ground truth 337 with the prediction 319. In an implementation, the comparison can yield a difference between or loss 321 between the prediction 319 and the ground truth 337. Loss 321 is illustrated as a difference between the ground truth 237 and the prediction 319 for each attribute and for each of visibility and existence. For example, with regard to the handbag, the loss is −0.71 for visibility and 0.26 for existence. This means that the prediction 319 was not even close in terms of visibility of the handbag and was a bit closer with regard to existence of the handbag. The comparison module 322 may include one or more or an attribute visibility comparison module (e.g., for comparing predicted attribute visibility with ground truth attribute visibility), an attribute existence comparison module (e.g., for comparing predicted attribute existence with ground truth attribute existence), and a visibility correlation comparison module (e.g., for comparing predicted attribute visibility correlation with a predetermined attribute visibility correlation).

The attribute identification model trainer 320 may include an attribute identification model modifier 324. The attribute identification model modifier 324 is executable by the computing system 300 to update the attribute identification model 310 based on the determined loss 321. For example, if the attribute identification model includes a machine learning algorithm, the loss 321 can backpropagate the loss 321 through the machine learning algorithm, causing adjustments to weights of edges in the machine learning model. The loss can be propagated for each sample, for each attribute, and/or for each of visibility and/or existence of the attribute. If the loss propagated is from more than one element of the prediction (e.g., more than one attribute and/or more than one of visibility and existence), the losses may be added. In instances where some losses are negative, the absolute value of the difference may be taken or may be made to have the same sign (e.g, by squaring). Backpropagation may involve propagating the loss in representative amounts to different weights in the model based on gradient determinations of sources of the loss in the model.

Code Example 1 is an example of pseudocode that can be used to train an attribute identification model 310.

### Code Example 1

| | |
|---|---|
| 1 | For epoch: |
| 2 | For iteration: |
| 3 | Loss = 0 |
| 4 | For sample: |
| 5 | For attribute_i in attributes: |
| 6 | Loss += distance(attribute_i_GT_visibility, attribute_i_pred_visibility) |
| 7 | Correlated_attribute_i_pred_visibility = Σ_{attribute}_{ⱼ}pred_corr(attributeᵢ,attributeⱼ) * attributeⱼ_{_{—}}pred_visibility |
| 8 | Loss += distance(attribute_i_GT_existence, attribute_i_pred_existence) * Correlated_attribute_i_pred_visibility |
| 9 | Loss.backprop( ) |
| 10 | Correlation_loss = distance(corr, pred_corr) |
| 11 | Correlation_loss.backprop( ) |

The pseudo-code is merely provided for purposes of demonstration. The first two lines represent for loops that iterate over epochs and iterations, respectively. The epoch represents the entirety of the labeled training data, and the for loop may include going over the full dataset a number of times. The iterations represent portions of the data in each epoch. The data may be apportioned in any way to introduce for training, and the orders and distributions of samples in the iterations may be randomized in order to prevent false local correlations and correlations to later or earlier samples (depending on the model). The third line of code sets the loss to zero for this iteration. This resets the loss quantity at the outset of each iteration.

The fourth line creates another nested for loop that iterates over samples in the current iteration. The fifth line creates still another nested for loop that iterates over the attributes. As indicated in the sixth line, within each nested attribute for loop, the loss term is adjusted to increase by an amount representing a distance (e.g., difference) between the ground truth visibility (attribute_i_GT_visibility) and predicted visibility (“attribute_i_pred_visibiliy”). In the seventh line, a correlation between the predicted visibility of attribute_i and each attribute_j (j being for all attributes in the list of attributes) is determined and summed. Each element of the summation may be multipled or otherwise weighted or scaled by the visibility of the attribute_j (attributeⱼ_pred_visibility). The correlation between the predicted visibility of attribute_i and the other attributes may be used to refine the relationship between visibility and existence, but determinations of this correlation may be omitted. The pred_corr elements may be a correlation array or matrix that represents the correlation between features. The illustrated implementation in line 7 may use a matrix multiplication and axis-aware summation where the correlation matrix is symmetric.

As can be seen in the eighth line, the distance or loss between the ground truth existence of the attribute (attribute_i_GT_existence) and the predicted existence of the attribute (attribute_i_pred_existence). In implementations in which the visibility correlation is used, the correlated attribute predicted visibility determined at the seventh line can be used in weighting or otherwise qualifying the loss attributable to predicted existence. In the eighth line, the distance is multiplied by the visibility correlation for the feature to help provide further resolution between the visibility of attributes and the existence of attributes. In implementations, the multiplication in the eighth line operates to attenuate the existence distance (that may be added to the loss term) with the visibility correlation value calculated in line 7. The operations represented by the seventh and/or the eighth line(s) may be omitted in situations where only the visibility is relevant or when the correlation between the visibility and the existence is not further accounted for by the attribute identification model 310. In the ninth line, the loss summed over each iteration is backpropagated through the attribute identification model 310 (e.g., by adjusting the weights of edges therein). Although illustrated as propagating the loss over each iteration, assessing losses over a single sample or multiple samples within iterations. Performing backpropagation at each iteration may save time and compute resources relative to the backpropagation at each sample. In implementations, loss can alternatively be aggregated and backpropagated separately for attribute visibility and existence. The tenth line determines a correlation loss representing a distance between the predicted correlation array and a known correlation array or matrix (e.g., a ground truth correlation that is preestablished). The eleventh line backpropagates the correlation loss at each epoch. It should be appreciated that the correlation backpropagation could also be conducted per iteration over even per sample, but this may increase compute costs and training times. Implementations are also contemplated in which the correlation matrix is predefined and static but provides the same context of relative visibility of attributes when determining loss for existence of attributes.

In implementations, the correlation between visibility of any two attributes may include a subtraction of a number of samples with different values for visibility on the two attributes from the number of samples with equal values for visibility on the two attributes, the result of the subtraction divided by the number of samples. In an implementation, correlation values for total agreement, total disagreement, and random (uncorrelated) agreement are 1.0, −1.0, and 0, respectively.

Table 1 shows an example attribute visibility correlation matrix for visibility of attributes.

TABLE 1
Visibility Correlation Matrix

| | Sleeve | Sleeve | Skirt/ | Bag | Bag |
|---|---|---|---|---|---|
| CORRELATION | Long | Short | Dress | Handbag | BackPack |
| Sleeve Long | 1 | 0.93 | 0.16 | 0.14 | 0.15 |
| Sleeve Short | 0.93 | 1 | 0.13 | 0.17 | 0.19 |
| Skirt/Dress | 0.16 | 0.13 | 1 | 0.35 | 0.16 |
| Bag Handbag | 0.14 | 0.17 | 0.35 | 1 | 0.07 |
| Bag BackPack | 0.15 | 0.19 | 0.16 | 0.07 | 1 |

The visibility correlation matrix represents a correlation between visibility of certain attributes. Table 1 illustrates perfect correlation as a value of one and total independence as zero. The diagonal of one values shows that each feature compared with itself is perfectly correlated, as is expected. The visibility may be correlated by the features being located in similar parts of the object being detected (e.g., located similarly relative to a human body). For example, even though the “Sleeve Long” and “Sleeve Short” may typically be mutually exclusive of one another, when one is visible the other is likely to be visible. As such, a correlation factor of 0.53 is shown. For existence determinations, it is not likely that a correlation between the existence of the two would be high, but visibility of the same areas dictates the likelihood that both are visible. An example of a demographic correlation is between the “Bag Handbag” and “Skirt/Dress.” Even though they are often located in different parts of the image, women may be more likely to have a skirt or dress and may be more likely to have handbags than men. This means that the correlation between the two may be higher than others (represented as 0.65). However, women do not always wear skirts or a dress, and there are instances where men who wear pants will carry a handbag, so the correlation will not be perfect. Another example of demographic-specific correlations can be demonstrated by the correlation between “Sleeves Short” and “Bag Backpack.” A strong correlation may exist between these two attributes because students are likely to have both backpacks and short sleeve shirts. The correlation may also cut against certain items that are not often used together. This may partially explain the lack of better correlation between visibility of the short sleeves and long sleeves. Another example is in the visibility correlation between “Bag BackPack” and “Bag HandBag” attributes. There may be little link between where the bags are situated in the images and the demographics who use the bags. Further, it may be more likely that a person carries only the one or the other, as the storage space may be sufficient in the one or the other.

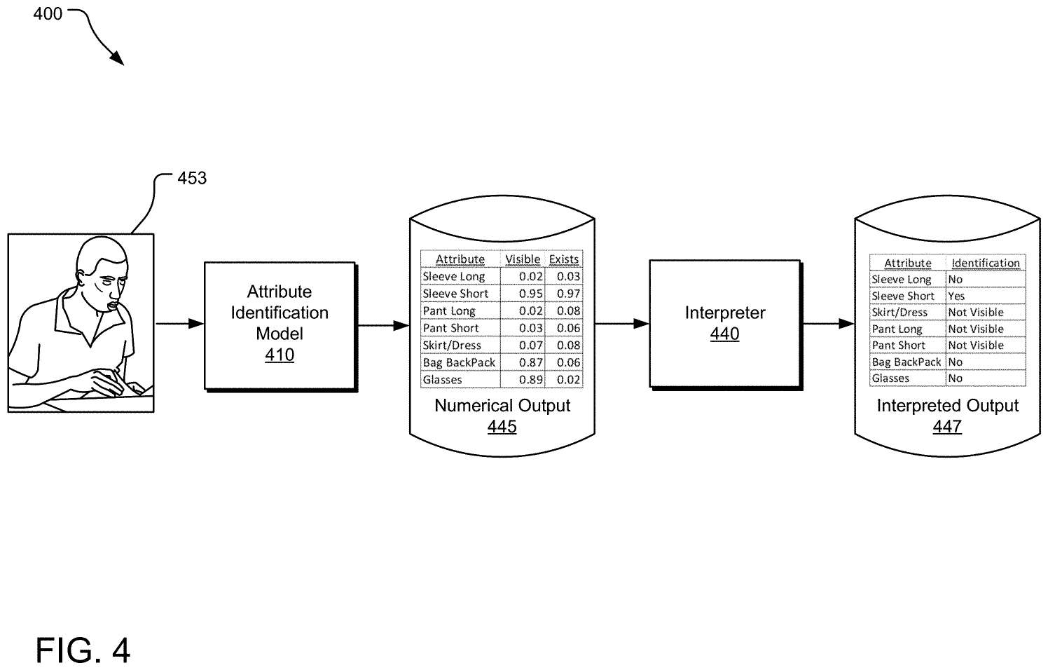

FIG. 4 illustrates still another example computing system 400 that accounts for visibility of attributes presented in an image for detection of the attributes. The attribute identification model 410 is already trained to determine one or more of visibility and existence of attributes associated with objects in images. The training may have been conducted as explained with regard to computing systems 200 and/or 300. An image 453 is inputted inti or otherwise introduced to the attribute identification model 410. The trained attribute identification model 410 has been trained to recognize certain features that indicate one or more of visibility and existence of attributes. The attribute identification model 410 outputs numerical output 445 representing predictions regarding the attributes. For example, with regard to “Pant Long,” the output is 0.02 for visibility and 0.08 for existence.

The numerical output 445 itself does not necessarily provide much information without interpretation. In this implementation, a value of one may indicate truth and a value of zero may indicate falsity. The interpreter 440 is executable by a processor of the computing system 400 to interpret the numerical output 445 and present meaningful qualitative outcomes of attribute detection. In the illustrated example, the values for “Pant Long” have been interpreted to mean that long pants are “Not Visible” in the image. The interpreter 440 may have rounded the values of 0.02 and 0.08 for “Pant Long” visibility and existence as zeros (e.g., by rounding). Thresholds or conditions other than rounding (e.g., other than greater than or less than 0.5) can be used to by the interpreter 440 to qualify numerical output 445. However, it can be seen that the interpreted output 447 from the interpreter 440 only presents a result of “Not Visible.” In this implementation, the interpreter 440 has decided that existence data is only provided if the attribute is detected as visible. In the image 453, the object of interest (i.e., illustrated here as a person) is sitting at a desk, and his legs are not visible. It is difficult from this image alone to know whether the person is wearing long pants, short pants, a skirt, a dress, or even nothing at all under the desk. As such, the interpreter 440 makes the decision that a “Not Visible” result is more meaningful than a result that predicts that the long pants do not exist. The decision tree for this interpreter 440 may first inquire whether the attribute is visible. If the attribute is not visible, the result yielded is “Not Visible.” If the attribute is visible, detection of its existence may be more likely to be correct, and a “Yes” or “No” will be provided representing whether the attribute exists with respect to the object. The image 453 illustrates a person with short sleeves clearly visible. As such, the visibility result of 0.95 and the existence result of 0.97 associated with the short sleeves can each be interpreted by the interpreter 440 as representing that the short sleeves are visible and exist in association with the object. Using the same decision tree, the interpreter 440 may determine to display the existence result of “Yes” in the interpreted output 447. In this implementation of an interpreter decision tree, there may be no outcomes in which the interpreted data explicitly show “Visible,” the “Yes” and “No” results implying the attribute is visible. Implementations are contemplated in which the interpreter 440 merely rounds the results and presents truth and falsity for each of visibility and existence for each of the attributes based on the relationship between truth and falsity and the rounded values.

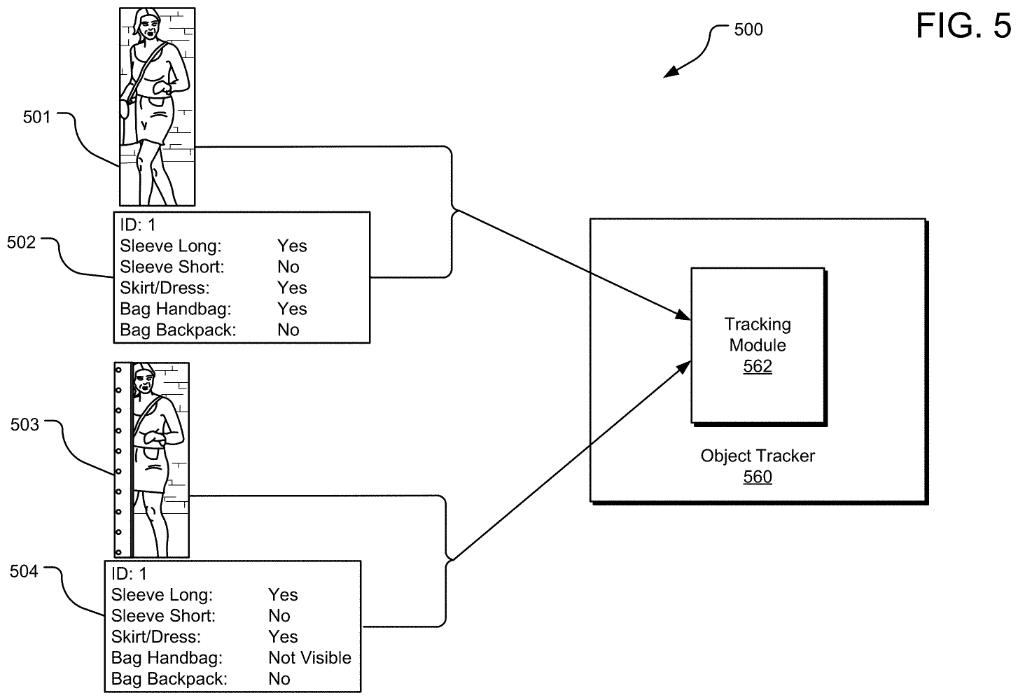

FIG. 5 illustrates an example of a tracking computer system 500. The tracking computer system includes an object tracker 560 with a tracking module 562. The object tracker 560 may be a standalone computer system or may be an element executable by a processor of the tracking computing system 500. The tracking module 562 is executable by a processor in one or more of the object tracker 560 and the computing system 500 to establish a track of an object in sequential images of a video. The tracking module may include a machine learning or other inferential model and may also be dynamically trainable using outputs of the attribute identification model. Images 501 and 503 are sequential images representing a woman walking. The woman has a handbag clearly visible in the first image 501. She continues to walk and is captured in the second image 503 with her handbag obscured or occluded by a pole in the foreground. These images 501 and 503 may each be inputted into or otherwise introduced to a trained attribute identification model (e.g., one or more of attribute identification models 210, 310, 410) and interpreted (e.g., by interpreter 440) to yield interpreted outputs 502 and 504, respectively. The tracking module 562 may receive the images 501, 503 and their associated respective interpreted outputs 502 and 504. While illustrated as two images 501 and 503, it can be appreciated that significantly more images of a video feed may be considered in a track of an object.

The tracking module 562 may utilize the information in the interpreted outputs for a number of applications. In an implementation, the tracking module 562 may see from the interpreted output 504 that the handbag is not visible in image 503. It may decide that the lack of visibility of the handbag makes the image 503 a bad one to maintain or establish a track and may discard or otherwise ignore the image 503. In implementations, the tracking module 562 may use the visibility detections to show increased confidence that the attribute exists in the image. The existence and visibility data can be used to create an indexed or cataloged inventory of tracks associated with the attributes at issue in order to emphasize tracking of objects with certain attributes.

For example, in a video feed of a procession of aircraft, the tracker may wish to identify and track aircraft that have jets and two tail fins. The attributes of jets and tail fins may be cataloged with respect to images in a video feed and tracking can be conducted more extensively or exclusively with respect to objects in captured images (e.g., of a video feed) that have the requested jets and tail fins. In the illustrated example, the object tracker 560 may be configured to track people with handbags and may use the determination that the handbag is not visible in image 503 to discount the value of or otherwise discard image 503 in the determination of whether images with an ID of “1” (the ID associated with the depicted individual) include a handbag. Cataloging the attributes relative to the images may allow for tracking of individuals to be grouped and further subgrouped based on the attributes. This may significantly reduce time trying to find objects with specified attributes.

In implementations, the tracking module 562 may also be configured to use the visibility output data to map occluding or obscuring environmental elements in a video feed. The images 501, 503 may be transmitted with further spatial relationship data to locate the objects in the image relative to mapped features in an environment. For example, the camera or other capture device that captures images 501, 503 may have a set position orange of positions of motion, and specific portions (e.g., bounding boxes) of the capture can be associated with a spatial map to relate the positions of objects in images to the spatial map. Associating certain items, such as the handbag in image 503, with output data that indicates the attribute is “Not Visible” can help indicate that there is an obstruction or occlusion in the way of the handbag. This can be reinforced over time to exclude instances where attributes are hidden by elements other than environmental elements (e.g, a handbag hidden under a jacket put on during a track). Also, the attributes themselves may partially dictate where to map the occlusions. For example, a handbag is expected to be in the center of a bounding box for a person. Therefore, the location within the bounding box may be used to determine that the occlusion affects the portion of the bounding box around the object that has the handbag or other attribute. The tracking module 562 may make this map initially with enough data and may further use it to determine whether people or other objects appear to be actively hiding an attribute. For example, if an attribute is not visible in a location that is not determined to be occluded, the tracking module 562 may determine that the lack of visibility is suspicious or that someone has left an item associated with the attribute somewhere in the video feed.

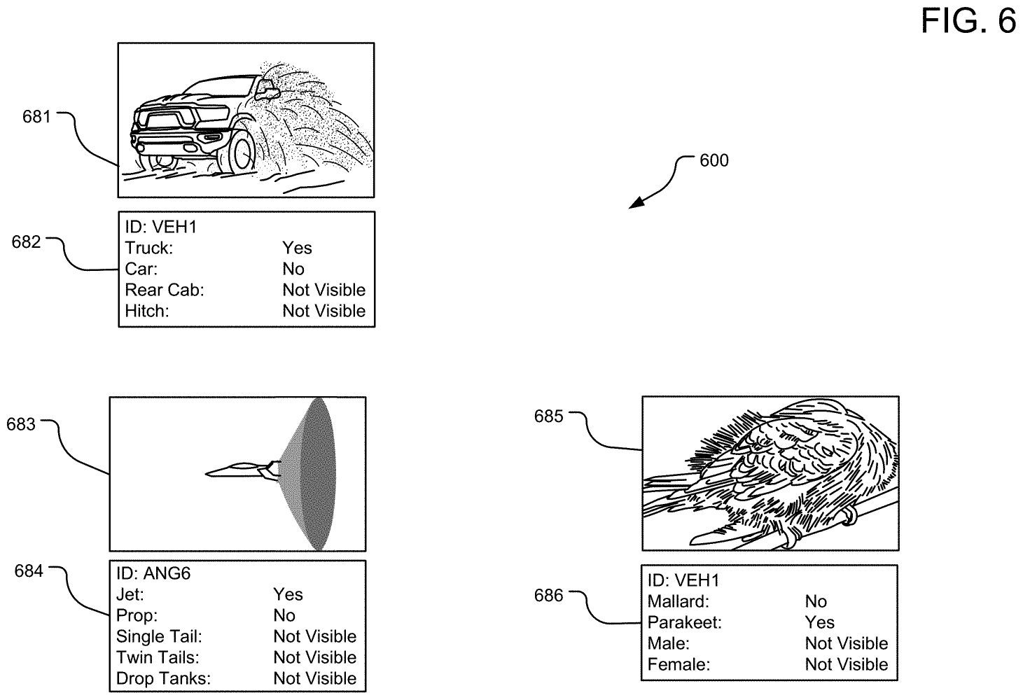

FIG. 6 illustrates examples of images of objects 600 and visibility of associated attributes. Illustrated examples presented in this specification have largely emphasized people and associated attributes as examples of objects with associated attributes. However, any object and associated attributes are contemplated for the purposes of this specification. First image 681 illustrates a vehicle as the object, and the vehicle is partially obscured by a large splash of mud. The first interpreted output 682 associated with the first image 681 identifies that the vehicle (object ID: VEH1) is a truck and not a car. However, the rear cab and hitch are interpreted to be “Not Visible.” This is because the rear cab and hitch, if present, are obscured by the mud splash. Second image 683 shows an aircraft (Object ID: ANG6). The aircraft is breaking the sound barrier and has formed a vapor cone. The second interpreted output 684 correctly identifies that the aircraft is a jet and is not a propellor plane. However, the second interpreted output 684 indicates that a number of tails and drop tanks are not visible attributes with a “Not Visible.” This is because these attributes are obscured and/or occluded by the vapor cone formed. Third image 685 shows a bird as the object, but the head is obscured. The third interpreted output 686 correctly identifies that the image is of a (budgerigar) parakeet and not a mallard. These species of bird happen to be dimorphic with external manifestations of sex. In the case of a parakeet, the clearest dimorphic feature is a color of the cere of the bird's head. The bird's head and, hence, cere are not visible in the image, as the bird is preening itself with its head obscured. Therefore, the third interpreted output 686 interprets the sex of the bird as “Not Visible.”

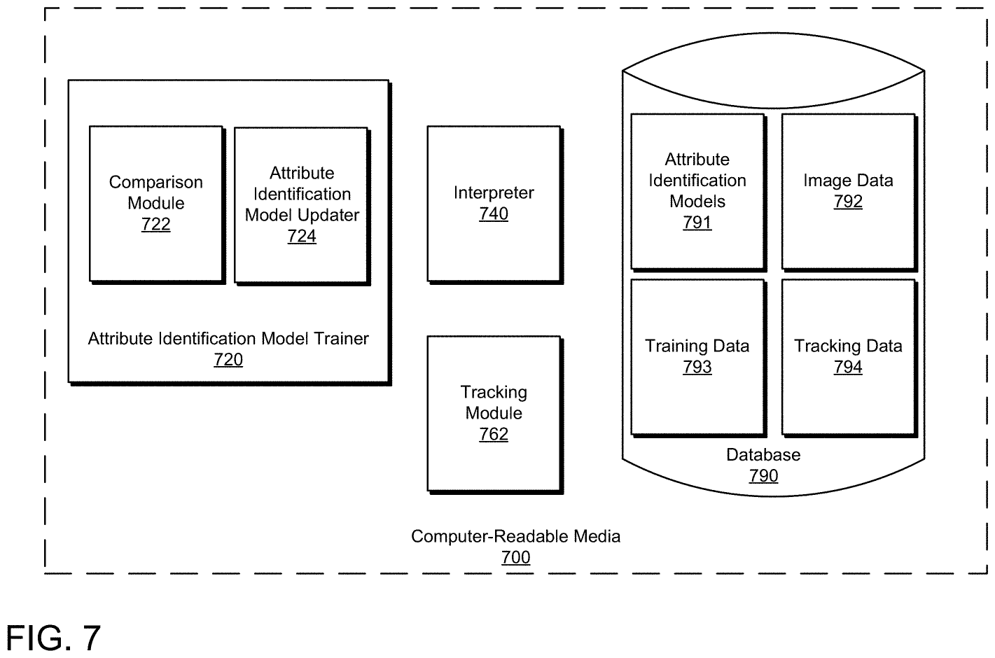

FIG. 7 illustrates example computer-readable media 700. While, in this implementation, the computer-readable media 700 is represented as including elements of a training system, a labeling/prediction system, and a tracking system, it should be appreciated that the computer-readable medium may not include all of these elements.

The computer-readable media 700 may include an attribute identification model trainer 720 which may be an implementation of one or more of attribute identification model trainers 220 and 320 The attribute identification model trainer 720 may train any of attribute identification models 791. The attribute identification model trainer 720 may include a comparison module 722 which may be an implementation of comparison module 322. Comparison module 722 is executable by a processor of a computing system to compare predictions generated from introducing images of a labeled training sample to an attribute identification model 791 with a ground truth of the labeled training sample. The comparison module 722 may also be responsible for comparing and/or determining loss between a predicted visibility correlation array and a predetermined or ground truth visibility correlation array. The attribute identification model trainer 720 may further include an attribute identification model updater 724 to execute by a process or a computer system to update or otherwise modify an attribute identification model 791. The attribute identification model updater 724 may backpropagate any loss or distance determined by the comparison module 722 through the attribute identification model 791.

An interpreter 740 is executable by a processor of a computing system to interpret numerical or otherwise raw output from an attribute identification model 791. The interpreter 740 may be an implementation of the interpreter 440. The decision tree for this interpreter 740 may first inquire whether the attribute is visible. If the attribute is not visible, the result yielded is “Not Visible.” If the attribute is visible, detection of its existence may be more likely to be correct, and a “Yes” or “No” will be provided representing whether the attribute exists with respect to the object. In this implementation of an interpreter decision tree, there may be no outcomes in which the interpreted data explicitly show “Visible,” the “Yes” and “No” results implying the attribute is visible. Alternative implementations are contemplated in which the interpreter 740 merely rounds the results and presents truth and falsity for each of visibility and existence for each of the attributes based on the relationship between truth and falsity and the rounded values.

Tracking module 762 is executable by a processor of a computing system to track objects as they move in captured video image sequences. The tracking module 762 may be an implementation of tracking module 562. The tracking module 762 may receive the images and their associated respective interpreted output. The tracking module 762 may utilize the information in the interpreted outputs for a number of applications. In an implementation, the tracking module 762 may see from the interpreted data that the handbag is not visible in an image. It may decide that the lack of visibility of a feature makes the image a bad example to maintain or establish a track and may discard or otherwise ignore the image. In implementations, the tracking module 762 may use the visibility detections to show increased confidence that the attribute exists in the image. The existence and visibility data can be used to create an indexed or cataloged inventory of tracks associated with the attributes at issue in order to emphasize tracking of objects with certain attributes.

In implementations, the tracking module 762 may also be configured to use the visibility output data to map occluding or obscuring environmental elements in a video feed. The images may be transmitted with further spatial relationship data to locate the objects in the images relative to mapped features in an environment. For example, the camera or other capture device that captures the images may have a set position or range of positions of motion, and specific portions (e.g., bounding boxes) of the capture can be associated with a spatial map to relate the positions of objects in images to the spatial map. Associating certain attributes with output data that indicates the attribute is “Not Visible” can help indicate that there is an obstruction or occlusion in the way of the handbag. This can be reinforced over time to exclude instances where attributes are hidden by elements other than environmental elements (e.g., a handbag hidden under a jacket put on during a track).

Also, the attributes themselves may partially dictate where to map the occlusions. For example, the location within the bounding box may be used to determine that the occlusion affects the portion of the bounding box around the object that has the handbag or other attribute. The tracking module 762 may make this map initially with enough data and may further use it to determine whether people or other objects appear to be actively hiding an attribute. For example, if an attribute is not visible in a location that is not determined to be occluded, the tracking module 762 may determine that the lack of visibility is suspicious or that someone has left an item associated with the attribute somewhere in the video feed.

The computer-readable media 700 may include a database 790. The database 790 may include attribute identification models 791 executable by a processor of a computing system to receive image input and output numerical and/or interpreted (in cases where the interpreter 740 is integral to the attribute identification model 791) output regarding one or more of visibility and existence data for attributes associated with the image input. The attribute identification models may be implementations of one or more of attribute identification models 210, 310, and 410. The database 790 may further include image data 792 representing images and perhaps, associated interpreted output. The image data may include two-dimensional or higher-dimensional arrays representing pixel values (whether in color or greyscale). The database 790 may further include training data 793. Training data can include labeled sample data, potentially including training image data and ground truth data. The training data 793 may further include intermediate results or performance results associated with the training of the attribute identification models 791. The database 790 may further include tracking data 794. Tracking data 794 may include any information useful in tracking. For example, the tracking data 794 may include sequential images used in a track, images omitted from a track, a map of occlusions, an index or catalog of objects with associated attributes to reference in order to isolate objects with indexed or cataloged attributes, and any of the data and intermediates used by the tracker.

Implementations are contemplated in which all of these elements are present in the computer-readable media 700. A training implementation of the computer-readable media 700 is contemplated that includes the attribute identification model trainer 720 with one or more of the comparison module 722 and the attribute identification model updater 724 and may further include a database with attribute identification models 791, image data 792, and training data 793. A prediction or interpreting implementation of the computer-readable media 700 is contemplated in which the attribute identification model 791 uses image data 792 from the database to generate output that is interpreted by the interpreter 740. A tracking implementation of the computer-readable media 700 may include the tracking module 762, which receives image data 792 with associated interpreted output and determines tracking data 794. Combinations of these implementations are contemplated. For example, the training implementation may be combined with the prediction or interpreting implementation to make a system that predicts and dynamically updates the attribute identification models 791 to incorporate training from the new elements (perhaps using an unsupervised learning method). The prediction or interpreting implementation can be combined with the tracking implementation to make the tracker able to also generate visibility and existence data for attributes associated with detected objects. All three implementations may be combined to make a dynamic training, predicting, and tracking system.

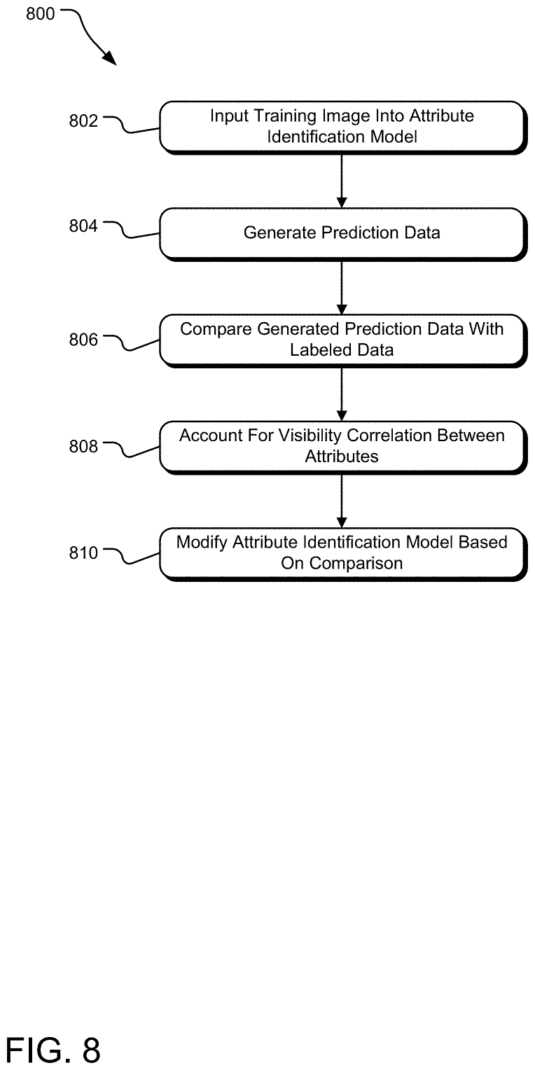

FIG. 8 illustrates example operations 800 for training an attribute identification model. One or more of the operations 800 may be conducted by an attribute identification model trainer (e.g., an implementation with features of one or more of attribute identification model trainers 220, 320, and 720). Inputting operation 802 inputs a training image into the untrained or partially trained attribute identification model. The image may be input as a two-dimensional or higher-dimensional array representing pixel values (e.g., greyscale or RGB values representing each pixel.

The attribute identification model may include an inferential model and/or a machine learning model executable by a processor of the computing system to take the data representing the image as input and apply weights on edges between the nodes in the logic of the attribute identification model to the data representing the image. The machine learning model may be initialized with edges including randomized weights or with a pre-trained model for general or specific applications (e.g., for objects such as humans, pre-trained models exist to recognize features of humans). Activation functions may also be used to introduce nonlinearity to determinations at one or more nodes o the attribute identification model. Examples of activation functions include Sigmoid, rectified linear unit (ReLU), hyperbolic tangent (tan h), Maxout, Leaky ReLU, arctangent, SoftPlus, and exponential linear unit (ELU). Examples of inferential and/or machine learning models include data mining algorithms, artificial intelligence algorithms, masked learning models, natural language processing models, neural networks, artificial neural networks, perceptrons, feed-forward networks, radial basis neural networks, deep feed forward neural networks, recurrent neural networks, long/short term memory networks, gated recurrent neural networks, auto encoders, variational auto encoders, denoising auto encoders, sparse auto encoders, Bayesian networks, regression models, decision trees, Markov chains, Hopfield networks, Boltzmann machines, restricted Boltzmann machines, deep belief networks, deep convolutional networks, genetic algorithms, deconvolutional neural networks, deep convolutional inverse graphics networks, generative adversarial networks, liquid state machines, extreme learning machines, echo state networks, deep residual networks, Kohonen networks, support vector machines, federated learning models, and neural Turing machines.

Generating operation 804 generates, by the attribute identification model, visibility prediction data based on the inputted training image. The data representing the image is passed through the attribute identification model and the weights between edges are applied to provide node values (perhaps with activation functions) to eventually, at an output layer of output nodes, output a prediction. The prediction can be assembled as an array of attribute values that represent the numerical values of likelihood of a condition being satisfied. For example, the results may yield a number between zero and one. Zero and one may be associated with a determination of falsity and truth, respectively, of the condition. This prediction can be with regard to one or more of visibility of and existence of an attribute associated or associable with a detected object in the image. For example, the prediction for visibility of a handbag associated with a person could have a value of 0.2. An interpreter in the machine learning computing system could interpret the value of 0.2 to be closer to zero than one and indicate that the visibility is zero or “False.” Even if the person in the image is wearing the handbag. Similarly, the prediction for existence of the handbag could be 0.8. An interpreter could determine that the handbag exists, even if it is not visible. This may be because the model includes memory from prior images in which the bag was determined to exist and be visible or because there is sufficient context in the image to determine that the handbag exists even if insufficiently visible to be considered visible. Interpreting in the training stage may be unnecessary, but the interpretation is presented here to provide context for the numbers of the prediction and the ground truth.

Comparing operation 806 compares generated prediction data with labeled data. The comparison can include determining a difference or loss between the prediction and the ground truth for one or more of attribute visibility and attribute existence. The loss can be added over an entire sample or can be determined per one or more of attribute, visibility of the attribute, and existence of the attribute.

Accounting operation 808 accounts for visibility correlation between attributes. The attribute identification model may account for any correlation between visibility of different attributes. Correlation between visibility of different attributes is described in reference to Code Example 1 and Table 1: Visibility Correlation Matrix presented in this specification. In implementations, the accounting operation 808 is an element of the comparing operation 806. The visibility correlation can be used to qualify the comparison of attribute existence to correlate the visibility with existence of the attributes. For example, the visibility correlation of an attribute may be used to qualify or weigh the loss determined between a ground truth existence and a predicted existence of an attribute (see e.g., line 8 of Code Example 1). The accounting operation 808 may be omitted in implementations where the visibility correlation is not used in the attribute identification model. Using the visibility correlation information in training may increase accuracy and decrease the training time of the attribute identification model.

Modifying operation 810 modifies the attribute identification model based on the comparison. In implementations. The attribute identification model trainer modifies the attribute identification model, based on the comparison of the comparing operation 806. The attribute identification model trainer may adjust the weights at the edges of the attribute identification model by backpropagating the difference or loss through the attribute identification model.

One or more of these operations 800 may be conducted for a number of labeled samples. As data representing more images are introduced to make predictions and the attribute identification model trainer compares them with the ground truth to modify the attribute identification model, the attribute identification model should be better trained to make predictions that are consistent with the trained ground truths. The attribute identification model trainer may continue to train the attribute identification model with the labeled sample data and may repeat with the labeled sample data in the same or different orders in the same or different iterations. The attribute identification model trainer may continue to train the model until a training condition is satisfied.

The model attribute identification model trainer may further validate the attribute identification model by testing the outputs of different labeled image data (e.g., other than labeled data) that were not included in the training. This may facilitate validation that the attribute identification model has not overfitted the labeled data. Failure in validation may indicate the attribute identification model trainer should introduce further labeled data to better train the model. Validation may be determined satisfactory based on whether a validation condition is satisfied. Known validation methods, such as k-fold cross-validation may be used. The training condition and/or validation condition may include a threshold of loss or difference for comparison of labeled and ground truth data for one or more of attribute visibility, attribute existence, and attribute visibility correlation. The threshold may additionally or alternatively include a certain number of iterations or epochs of training.

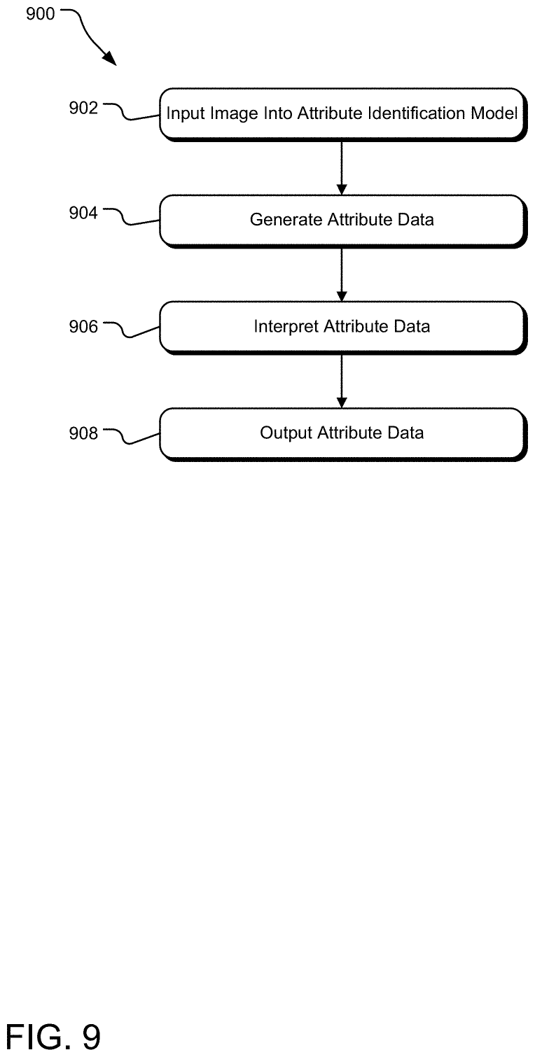

FIG. 9 illustrates example operations 900 for generating attribute data using an attribute identification model. In this implementation, the attribute identification module is already trained to identify visibility of attributes. Inputting operation 902 inputs data representing an image into an attribute identification model. The attribute identification model may be an implementation of one or more of attribute identification models 210, 310 410, and 791.

Generating operation 904 generates output data representing one or more of attribute visibility and attribute existence. The attribute data is generated based on the inputted image and the parameters (e.g., weights) of the attribute identification model.

Interpreting operation 906 interprets the generated attribute data. The generated attribute data may be raw numbers that do not represent the meaning of the generated attribute data. The interpreting operation 906 converts the information into labels usable by people. The interpretation operation 906 may be conducted by an interpreter (e.g., one including features of implementations of one or more of interpreters 440 and 740). In implementations, interpretation may not be necessary if the data is directly fed into another system that is preprogrammed to accept the input as raw numbers. In these implementations where interpretation is not necessary, interpreting operation 906 may be omitted.

Outputting operation 908 outputs the attribute data. The outputted attribute data may be interpreted attribute data. The data may be outputted to a user on a user or interface or may be further used in other applications. For example, the information could be output to software that uses the information for mapping and/or tracking or any other application for which attribute visibility and/or existence data associated or associable with an object in an image is used.

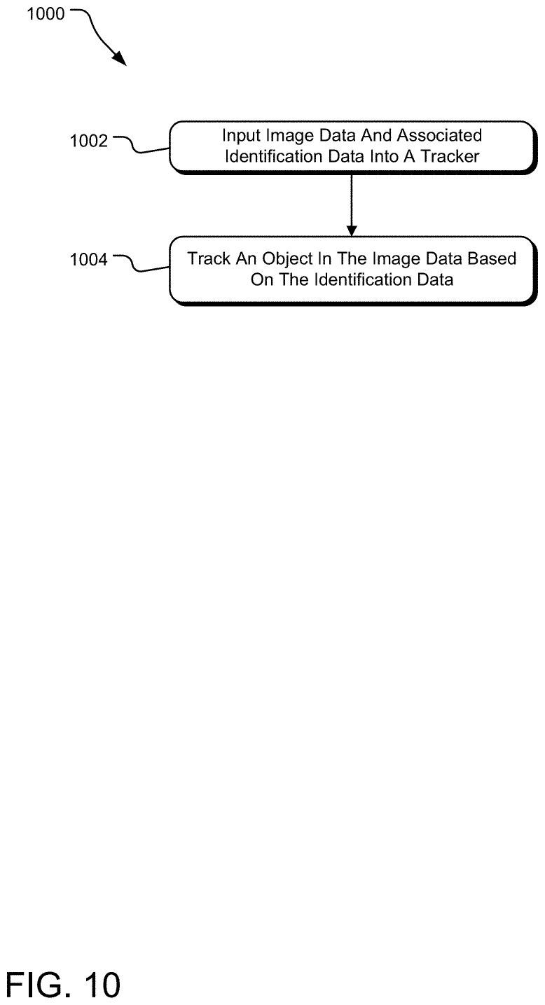

FIG. 10 illustrates example operations 1000 for using generated attribute data in a tracking application. Inputting operation 1002 inputs an image and associated generated attribute data into a tracker. The generated attribute data may be attribute data generated from inputting the image into an attribute identification model The tracker may be an implementation of and/or include features of object tracker 560. The tracker may include a tracking module executable by a processor in one or more of an object tracker and a computing system to establish a track of an object in sequential images of a video. The tracking module may receive the images and their associated respective generated data (e.g., interpreted or uninterpreted outputs from the attribute identification model).

The tracking module may utilize the information in the outputs for a number of applications. In an implementation, the tracking module may see from the interpreted data that an attribute is not visible in an image. It may decide that the lack of visibility of the attribute makes the image a bad one to maintain or establish a track and may discard or otherwise ignore the image. In implementations, the tracking module may use attribute visibility detections to show increased confidence that the attribute exists in the image. In implementations, the existence and visibility data is used to create an indexed or cataloged inventory of tracks associated with the attributes at issue in order to emphasize tracking of objects with certain attributes. For example, in a video feed of a procession of aircraft, the tracker may wish to identify and track aircraft that have jets and two tail fins. The attributes of jets and tail fins may be cataloged with respect to images in a video feed and tracking can be conducted more extensively or exclusively with respect to objects in captured images (e.g., of a video feed) that have the requested jets and tail fins.

In implementations, the tracking module may also be configured to use the visibility output data to map occluding or obscuring environmental elements in a video feed. The inputted images may be transmitted with further spatial relationship data to locate the objects in the image relative to mapped features in an environment. For example, the camera or other capture device that captures images may have a set position or a range of positions of motion, and specific portions (e.g., bounding boxes) of the capture can be associated with a spatial map to relate the positions of objects in images to the spatial map. Providing certain attributes associated with output data that indicates the attribute is “Not Visible” can help indicate that there is an obstruction or occlusion in the way of the attribute. This can be reinforced over time to exclude instances where attributes are hidden by elements other than environmental elements (e.g., a handbag hidden under a jacket put on during a track).

In implementations, the attributes themselves may partially dictate where to map the occlusions. For example, a handbag is expected to be in the center of a bounding box for a person. Therefore, the location within the bounding box may be used to determine that the occlusion affects the portion of the bounding box around the object that has the handbag or other attribute. The tracking module may initially generate this map with sufficient data to map environmental occlusions and may further use it to determine whether people or other objects appear to be actively hiding an attribute. For example, if an attribute is not visible in a location that is not determined to be occluded, the tracking module may determine that the lack of visibility is suspicious or that someone has left an item associated with the attribute somewhere in the video feed.

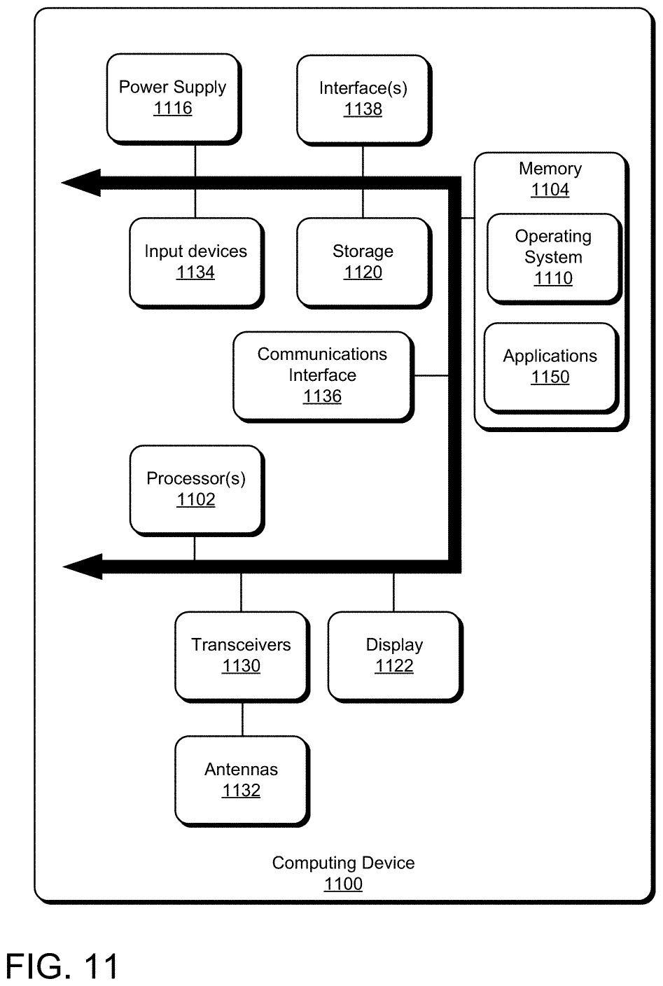

FIG. 11 illustrates an example computing device 1100 for implementing the features and operations of the described technology. The computing device 1100 may embody a remote-control device or a physical controlled device and is an example network-connected and/or network-capable device and may be a client device, such as a laptop, mobile device, desktop, tablet; a server/cloud device; an internet-of-things device; an electronic accessory; or another electronic device. The computing device 1100 may be an implementation of or include features of implementations of one or more of computing devices 200, 300, 400, and 500 or the computing devices 1100 described with regard to FIGS. 1 and FIGS. 7-10. The computing device 1100 includes one or more processor(s) 1102 and a memory 1104. The memory 1104 generally includes both volatile memory (e.g., RAM) and nonvolatile memory (e.g., flash memory). An operating system 1110 resides in the memory 1104 and is executed by the processor(s) 1102.

In an example computing device 1100, as shown in FIG. 11, one or more modules or segments, such as applications 1150, comparison modules (e.g., attribute visibility comparison modules, attribute existence comparison modules, and visibility correlation comparison modules), attribute identification model modifiers, intepreters, image inputters, attribute identification model trainers, attribute identification models, tracking modules, inferential models, machine learning models include data mining algorithms, artificial intelligence algorithms, masked learning models, natural language processing models, neural networks, artificial neural networks, perceptrons, feed forward networks, radial basis neural networks, deep feed forward neural networks, recurrent neural networks, long/short term memory networks, gated recurrent neural networks, auto encoders, variational auto encoders, denoising auto encoders, sparse auto encoders, Bayesian networks, regression models, decision trees, Markov chains, Hopfield networks, Boltzmann machines, restricted Boltzmann machines, deep belief networks, deep convolutional networks, genetic algorithms, deconvolutional neural networks, deep convolutional inverse graphics networks, generative adversarial networks, liquid state machines, extreme learning machines, echo state networks, deep residual networks, kohonen networks, support vector machines, federated learning models, and neural Turing machines are loaded into the operating system 1110 on the memory 1104 and/or storage 1120 and executed by processor(s) 1102. The storage 1120 may include one or more tangible storage media devices and may store image data, attribute identification models, predictions, training data, tracking data, numerical output, interpreted output, loss, ground truths, labels, labeled data, labeled data samples, visibility correlations, attribute visibilities, attribute existences, object identifiers, image identifiers, tracking identifiers, locally and globally unique identifiers, requests, responses, and other data and be local to the computing device 1100 or may be remote and communicatively connected to the computing device 1100.

The computing device 1100 includes a power supply 1116, which is powered by one or more batteries or other power sources and which provides power to other components of the computing device 1100. The power supply 1116 may also be connected to an external power source that overrides or recharges the built-in batteries or other power sources.

The computing device 1100 may include one or more communication transceivers 1130, which may be connected to one or more antenna(s) 1132 to provide network connectivity (e.g., mobile phone network, Wi-Fi®, Bluetooth®) to one or more other servers and/or client devices (e.g., mobile devices, desktop computers, or laptop computers). The computing device 1100 may further include a network adapter 1136, which is a type of computing device. The computing device 1100 may use the adapter and any other types of computing devices for establishing connections over a wide-area network (WAN) or local-area network (LAN). It should be appreciated that the network connections shown are examples and that other computing devices and means for establishing a communications link between the computing device 1100 and other devices may be used.

The computing device 1100 may include one or more input devices 1134 such that a user may enter commands and information (e.g., a keyboard or mouse). These and other input devices may be coupled to the server by one or more interfaces 1138, such as a serial port interface, parallel port, or universal serial bus (USB). The computing device 1100 may further include a display 1122, such as a touch screen display.

The computing device 1100 may include a variety of tangible processor-readable storage media and intangible processor-readable communication signals. Tangible processor-readable storage can be embodied by any available media that can be accessed by the computing device 1100 and includes both volatile and nonvolatile storage media, removable and non-removable storage media. The tangible processor-readable storage media may be an implementation of computer-readable media 700. Tangible processor-readable storage media excludes communications signals (e.g., signals per se) and includes volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 1100. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Various software components described herein are executable by one or more processors, which may include logic machines configured to execute hardware or firmware instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Aspects of processors and storage may be integrated together into one or more hardware logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of a remote-control device and/or a physically controlled device implemented to perform a particular function. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across one or multiple user sessions. A service may be available to one or more system components, programs, and/or other services. In some implementations, a service may run on one or more server computing devices.

The logical operations making up implementations of the technology described herein may be referred to variously as operations, steps, objects, or modules. Furthermore, it should be understood that logical operations may be performed in any order, adding or omitting operations as desired, regardless of whether operations are labeled or identified as optional, unless explicitly claimed otherwise or a specific order is inherently necessitated by the claim language.

An example computer-implemented method of accounting for visibility of a first attribute of one or more attributes associable with an object presented in an image is provided. The method includes inputting a training image of a first object into an attribute identification machine learning model, the training image being associated with labeled visibility data indicating whether the first attribute is visible in the inputted training image, generating, based on the inputted training image, visibility prediction data representing a prediction by the attribute identification machine learning model as to whether the first attribute is predicted to be visible in the inputted training image, comparing the generated visibility prediction data with labeled visibility data, and modifying the attribute identification machine learning model based on the comparison of the generated visibility prediction data and the labeled visibility data.

Another example computer-implemented method of any preceding method is provided, wherein the operation of generating further generates existence prediction data representing whether the first attribute associable with the first object exists in the inputted training image. The method further includes comparing the existence prediction data with labeled existence data, the labeled existence data including one or more ground truths of existence of the first attribute in the inputted training image, wherein the operation of modifying is further based on the comparison of the existence prediction data with the labeled existence data.

Another example computer-implemented method of any preceding method is provided, wherein the operation of modifying is further based on a predicted visibility correlation between a visibility of the first attribute and a visibility of a second of the one or more attributes in the comparison between the existence prediction data and the labeled existence data.

Another example computer-implemented method of any preceding method is provided, the computer-implemented method further including comparing the predicted visibility correlation with a predetermined visibility correlation between the visibility of the first attribute and the visibility of a different second attribute, wherein the operation of modifying the attribute identification machine learning model is further based on the comparison of the predicted visibility correlation with the predetermined visibility correlation.

Another example computer-implemented method of any preceding method is provided, wherein the operation of modifying the attribute identification machine learning model further based on the comparison of the predicted visibility correlation with the predetermined visibility correlation includes determining a metric representing a difference between the predicted visibility correlation and the predetermined visibility correlation, wherein the modification of the attribute identification machine learning model further based on the comparison between the existence prediction data and the labeled existence data is based on the metric.

Another example computer-implemented method of any preceding method is provided, further including selecting the training image, prior to the operation of inputting, based on whether an occlusion is present that at least partially obscures at least one of the one or more attributes in the training image.

Another example computer-implemented method of any preceding method is provided, further including inputting an unlabeled image with a second object into the modified attribute identification machine learning model and determining, from the modified attribute identification machine learning model, whether the first attribute is visible in the unlabeled image.

An example computing device for accounting for visibility of a first attribute of one or more attributes associable with an object presented in an image is provided. The computing device includes a processor and memory, the processor configured to execute instructions stored in the memory. The computing device further includes an attribute identification machine learning model executable by the processor to generate data representing features associable with one or more objects presented in one or more images and an attribute identification machine learning model trainer executable by the processor. The attribute identification machine learning model includes an image inputter executable by the processor to input a training image of a first object into an attribute identification machine learning model, the training image being associated with labeled visibility data indicating whether the first attribute is visible in the inputted training image, wherein the attribute identification machine learning model is configured to generate, based on the inputted training image, visibility prediction data representing whether the first attribute is predicted to be visible in the inputted training image, a visibility comparison module executable by the processor to compare the generated visibility prediction data with labeled visibility data, and an attribute identification machine learning model modifier executable by the processor to modify the attribute identification machine learning model based on the comparison of the generated visibility prediction data and the labeled visibility data.

Another example computing device of any preceding device is provided, wherein the attribute identification machine learning model is further configured to generate existence prediction data representing whether the first attribute associable with the first object exists in the inputted training image. The attribute identification machine learning model trainer further includes an existence comparison module executable by the processor to compare the existence prediction data with labeled existence data, the labeled existence data including one or more ground truths of existence of the first attribute in the inputted training image, wherein the attribute identification machine learning model modifier modifies the attribute identification machine learning model further based on the comparison of the existence prediction data and the labeled existence data.

Another example computing device of any preceding device is provided, wherein the existence comparison module compares the existence prediction data with the labeled existence data based on a predicted visibility correlation between a visibility of the first attribute and a visibility of a second of the one or more attributes.

Another example computing device of any preceding device is provided, the computing device further including a visibility correlation comparison module executable by the processor to compare the predicted visibility correlation with a predetermined visibility correlation, wherein the attribute identification machine learning model modifier is configured to modify the attribute identification machine learning model further based on the comparison of the predicted visibility correlation with the predetermined visibility correlation.

Another example computing device of any preceding device is provided, wherein the attribute identification machine learning model modifier is configured to modify the attribute identification machine learning model further based on the comparison of the predicted visibility correlation with the predetermined visibility correlation by the visibility correlation comparison module being configured to determine a metric representing a difference between the predicted visibility correlation and the predetermined visibility correlation and the existence comparison module being configured to compare the existence prediction data and the labeled existence data based on the determined metric.

Another example computing device of any preceding device is provided, the computing device further including a training image selector executable by the processor to select the training image, prior to the input of the inputted image, based on whether an occlusion is present that at least partially obscures at least one of the one or more attributes in the training image.

Another example computing device of any preceding device is provided, wherein the image inputter is further configured to input an unlabeled image into the attribute identification machine learning model. The computing device further includes an interpreter executable by the processor to determine, from the modified attribute identification machine learning model, whether the first attribute is visible in the unlabeled image.

One or more example tangible processor-readable storage media embodied with instructions for executing on one or more processors and circuits of a computing device a process for accounting for visibility of a first attribute of one or more attributes associable with an object presented in an image is provided. The process includes inputting a training image of a first object into an attribute identification machine learning model, the training image being associated with labeled visibility data indicating whether the first attribute is visible in the inputted training image, generating, based on the inputted training image, visibility prediction data representing a prediction by the attribute identification machine learning model as to whether the first attribute is predicted to be visible in the inputted training image, comparing the generated visibility prediction data with labeled visibility data, and modifying the attribute identification machine learning model based on the comparison of the generated visibility prediction data and the labeled visibility data.

One or more other example tangible processor-readable storage media of any preceding media is provided, wherein the operation of generating further generates existence prediction data representing whether the first attribute associable with the first object exists in the inputted training image. The process further includes comparing the existence prediction data with labeled existence data, the labeled existence data including one or more ground truths of existence of the first attribute in the inputted training image, wherein the operation of modifying is further based on the comparison of the existence prediction data and the labeled existence data.

One or more other example tangible processor-readable storage media of any preceding media is provided, wherein the operation of modifying is further based on a predicted visibility correlation between a visibility of the first attribute and a visibility of a second of the one or more attributes in the comparison between the existence prediction data and the labeled existence data.

One or more other example tangible processor-readable storage media of any preceding media is provided, wherein the process further includes comparing the predicted visibility correlation with a predetermined visibility correlation between the visibility of the first attribute and the visibility of a different second attribute, wherein the operation of modifying the attribute identification machine learning model is further based on the Microsoft Technology Licensing, LLC 31 comparison of the predicted visibility correlation with the predetermined visibility correlation.

One or more other example tangible processor-readable storage media of any preceding media is provided, wherein the operation of modifying the attribute identification machine learning model further based on the comparison of the predicted visibility correlation with the predetermined visibility correlation includes determining a metric representing a difference between the predicted visibility correlation and the predetermined visibility correlation, wherein the modification of the attribute identification machine learning model further based on the comparison between the existence prediction data and the labeled existence data is based on the metric.

One or more other example tangible processor-readable storage media of any preceding media is provided, wherein the process further includes inputting an unlabeled image with a second object into the modified attribute identification machine learning model and determining, from the modified attribute identification machine learning model, whether the first attribute is visible in the unlabeled image.

An example system of accounting for visibility of a first attribute of one or more attributes associable with an object presented in an image is provided. The system includes means for inputting a training image of a first object into an attribute identification machine learning model, the training image being associated with labeled visibility data indicating whether the first attribute is visible in the inputted training image, means for generating, based on the inputted training image, visibility prediction data representing a prediction by the attribute identification machine learning model as to whether the first attribute is predicted to be visible in the inputted training image, means for comparing the generated visibility prediction data with labeled visibility data, and means for modifying the attribute identification machine learning model based on the comparison of the generated visibility prediction data and the labeled visibility data.

Another example system of any preceding system is provided, wherein the generation further generates existence prediction data representing whether the first attribute associable with the first object exists in the inputted training image. The system further includes means for comparing the existence prediction data with labeled existence data, the labeled existence data including one or more ground truths of existence of the first attribute in the inputted training image, wherein the modification is further based on the comparison of the existence prediction data with the labeled existence data.

Another example system of any preceding system is provided, wherein the modification is further based on a predicted visibility correlation between a visibility of the first attribute and a visibility of a second of the one or more attributes in the comparison between the existence prediction data and the labeled existence data.

Another example system of any preceding system is provided, further including means for comparing the predicted visibility correlation with a predetermined visibility correlation between the visibility of the first attribute and the visibility of a different second attribute, wherein the modification of the attribute identification machine learning model is further based on the comparison of the predicted visibility correlation with the predetermined visibility correlation.

Another example system of any preceding system is provided, wherein the means for modifying the attribute identification machine learning model further based on the comparison of the predicted visibility correlation with the predetermined visibility correlation includes means for determining a metric representing a difference between the predicted visibility correlation and the predetermined visibility correlation, wherein the modification of the attribute identification machine learning model is further based on the comparison between the existence prediction data and the labeled existence data is based on the metric.

Another example system of any preceding system is provided, further including means for selecting the training image, prior to the inputting, based on whether an occlusion is present that at least partially obscures at least one of the one or more attributes in the training image.

Another example system of any preceding system is provided, further including means for inputting an unlabeled image with a second object into the modified attribute identification machine learning model and means for determining, from the modified attribute identification machine learning model, whether the first attribute is visible in the unlabeled image.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the described technology have been described. Nevertheless, it will be understood that various modifications can be made without departing from the spirit and scope of the recited claims.

What is claimed is:

1. A computer-implemented method of accounting for visibility of a first attribute of one or more attributes associable with an object presented in an image, the method comprising:
inputting a training image of a first object into an attribute identification machine learning model, the training image being associated with labeled visibility data indicating whether the first attribute is visible in the inputted training image;
generating, based on the inputted training image, visibility prediction data representing a prediction by the attribute identification machine learning model as to whether the first attribute is predicted to be visible in the inputted training image;
comparing the generated visibility prediction data with labeled visibility data; and
modifying the attribute identification machine learning model based on the comparison of the generated visibility prediction data and the labeled visibility data.

2. The computer-implemented method of claim 1, wherein the operation of generating further generates existence prediction data representing whether the first attribute associable with the first object exists in the inputted training image, the method further comprising:
comparing the existence prediction data with labeled existence data, the labeled existence data including one or more ground truths of existence of the first attribute in the inputted training image,
wherein the operation of modifying is further based on the comparison of the existence prediction data with the labeled existence data.

3. The computer-implemented method of claim 2, wherein the operation of modifying is further based on a predicted visibility correlation between a visibility of the first attribute and a visibility of a second of the one or more attributes in the comparison between the existence prediction data and the labeled existence data.

4. The computer-implemented method of claim 3, further comprising:
comparing the predicted visibility correlation with a predetermined visibility correlation between the visibility of the first attribute and the visibility of a different second attribute, wherein the operation of modifying the attribute identification machine learning model is further based on the comparison of the predicted visibility correlation with the predetermined visibility correlation.

5. The computer-implemented method of claim 4, wherein the operation of modifying the attribute identification machine learning model further based on the comparison of the predicted visibility correlation with the predetermined visibility correlation comprises:
determining a metric representing a difference between the predicted visibility correlation and the predetermined visibility correlation, wherein the modification of the attribute identification machine learning model further based on the comparison between the existence prediction data and the labeled existence data is based on the metric.

6. The computer-implemented method of claim 1, further comprising:
selecting the training image, prior to the operation of inputting, based on whether an occlusion is present that at least partially obscures at least one of the one or more attributes in the training image.

7. The computer-implemented method of claim 1, further comprising:
inputting an unlabeled image with a second object into the modified attribute identification machine learning model; and
determining, from the modified attribute identification machine learning model, whether the first attribute is visible in the unlabeled image.

8. A computing device for accounting for visibility of a first attribute of one or more attributes associable with an object presented in an image, the computing device including a processor and memory, the processor configured to execute instructions stored in the memory, the computing device comprising:
an attribute identification machine learning model executable by the processor to generate data representing features associable with one or more objects presented in one or more images; and
an attribute identification machine learning model trainer executable by the processor, including:
an image inputter executable by the processor to input a training image of a first object into an attribute identification machine learning model, the training image being associated with labeled visibility data indicating whether the first attribute is visible in the inputted training image, wherein the attribute identification machine learning model is configured to generate, based on the inputted training image, visibility prediction data representing whether the first attribute is predicted to be visible in the inputted training image;
a visibility comparison module executable by the processor to compare the generated visibility prediction data with labeled visibility data; and
an attribute identification machine learning model modifier executable by the processor to modify the attribute identification machine learning model based on the comparison of the generated visibility prediction data and the labeled visibility data.

9. The computing device of claim 0, wherein the attribute identification machine learning model is further configured to generate existence prediction data representing whether the first attribute associable with the first object exists in the inputted training image, the attribute identification machine learning model trainer further comprising:
an existence comparison module executable by the processor to compare the existence prediction data with labeled existence data, the labeled existence data including one or more ground truths of existence of the first attribute in the inputted training image,
wherein the attribute identification machine learning model modifier modifies the attribute identification machine learning model further based on the comparison of the existence prediction data and the labeled existence data.

10. The computing device of claim 9, wherein the existence comparison module compares the existence prediction data with the labeled existence data based on a predicted visibility correlation between a visibility of the first attribute and a visibility of a second of the one or more attributes.

11. The computing device of claim 10, further comprising:
a visibility correlation comparison module executable by the processor to compare the predicted visibility correlation with a predetermined visibility correlation, wherein the attribute identification machine learning model modifier is configured to modify the attribute identification machine learning model further based on the comparison of the predicted visibility correlation with the predetermined visibility correlation.

12. The computing device of claim 11, wherein the attribute identification machine learning model modifier is configured to modify the attribute identification machine learning model further based on the comparison of the predicted visibility correlation with the predetermined visibility correlation by the visibility correlation comparison module being configured to determine a metric representing a difference between the predicted visibility correlation and the predetermined visibility correlation and the existence comparison module being configured to compare the existence prediction data and the labeled existence data based on the determined metric.

13. The computing device of claim 0, further comprising:
a training image selector executable by the processor to select the training image, prior to the input of the inputted image, based on whether an occlusion is present that at least partially obscures at least one of the one or more attributes in the training image.

14. The computing device of claim 0, wherein the image inputter is further configured to input an unlabeled image into the attribute identification machine learning model, the computing device further comprising:
an interpreter executable by the processor to determine, from the modified attribute identification machine learning model, whether the first attribute is visible in the unlabeled image.

15. One or more tangible processor-readable storage media embodied with instructions for executing on one or more processors and circuits of a computing device a process for accounting for visibility of a first attribute of one or more attributes associable with an object presented in an image, the process comprising:
inputting a training image of a first object into an attribute identification machine learning model, the training image being associated with labeled visibility data indicating whether the first attribute is visible in the inputted training image;
generating, based on the inputted training image, visibility prediction data representing a prediction by the attribute identification machine learning model as to whether the first attribute is predicted to be visible in the inputted training image;
comparing the generated visibility prediction data with labeled visibility data; and
modifying the attribute identification machine learning model based on the comparison of the generated visibility prediction data and the labeled visibility data.

16. The one or more tangible processor-readable storage media of claim 15, wherein the operation of generating further generates existence prediction data representing whether the first attribute associable with the first object exists in the inputted training image, the process further comprising:
comparing the existence prediction data with labeled existence data, the labeled existence data including one or more ground truths of existence of the first attribute in the inputted training image,
wherein the operation of modifying is further based on the comparison of the existence prediction data and the labeled existence data.

17. The one or more tangible processor-readable storage media of claim 16, wherein the operation of modifying is further based on a predicted visibility correlation between a visibility of the first attribute and a visibility of a second of the one or more attributes in the comparison between the existence prediction data and the labeled existence data.

18. The one or more tangible processor-readable storage media of claim 17, the process further comprising:
comparing the predicted visibility correlation with a predetermined visibility correlation between the visibility of the first attribute and the visibility of a different second attribute, wherein the operation of modifying the attribute identification machine learning model is further based on the comparison of the predicted visibility correlation with the predetermined visibility correlation.

19. The one or more tangible processor-readable storage media of claim 18, wherein the operation of modifying the attribute identification machine learning model further based on the comparison of the predicted visibility correlation with the predetermined visibility correlation comprises:
determining a metric representing a difference between the predicted visibility correlation and the predetermined visibility correlation, wherein the modification of the attribute identification machine learning model further based on the comparison between the existence prediction data and the labeled existence data is based on the metric.

20. The one or more tangible processor-readable storage media of claim 15, the process further comprising:
inputting an unlabeled image with a second object into the modified attribute identification machine learning model; and
determining, from the modified attribute identification machine learning model, whether the first attribute is visible in the unlabeled image.
